(19) United States
(12) Patent Application Publication
(10) Pub. No.: US 2008/0122931 A1
(43) Pub. Date: May 29, 2008

(54) Wireless Sports Training Device

(76) Inventors: Walter Nicholas Simbirski, Calgary (CA); Dusty Keashly, Irricana (CA)

Correspondence Address: Walter Simbirski, 57 Cranberry Way SE, Calgary, AB, T3M1K2, omitted

(21) Appl. No.: 11/424,864

(22) Filed: Jun. 17, 2006

(51) Int. Cl. H04N 7/18

(52) U.S. Cl. 348/157; 348/E07.085

(57) ABSTRACT

A real time video image of a person performing a physical activity is provided to the person performing the activity without interfering with their ability to perform the activity or the location where the activity is performed.

### BACKGROUND

A person engaged in a physical activity may rely on visual clues to determine if the desired position or movement of a body part (or parts) or equipments such as a golf club, fishing rod, or tennis racket is achieved. In some cases the movement occurs outside of the person's field of view or requires the person to change the position or orientation of their head or eyes to observe the position or movement. This change of position or reorientation of the head or eyes can interfere with the ability to achieve the desired position or perform the desired movement.

Where direct visual observation is not possible the person performing the physical activity must rely on feedback from a coach or instructor to provide ongoing criticism of their performance in order to determine if their performance is improving. Alternatively, video imagery can be captured for later playback so that the person engaging in the activity can see for themselves if they are improving or to identify specific areas for later improvement. Various means have been implemented for feedback in the absence of a trained coach. These include the use of mirrors, various forms of analytical devices as described in US Patent Application:

20030024311 Perkins

and audio feedback devices such as described in Canadian Patent:

CA 210941 Dawson.

Mirrors provide immediate visual feedback but may not be readily available, may produce unsatisfactory imagery, or may require the person engaged in the activity to change the position or orientation required to properly perform the activity. Analytic devices may not provide real time feedback and audio devices may limit the information that can be presented to the person engaged in the sporting activity. In addition, there is often a need for the person performing the activity to “see for themselves” what they are doing in order to trust the information provided by analytical devices.

To date, one of the best forms of feedback for persons engaged in certain sporting activities is to review the performance of their activity recorded with a video camera. The person then reviews various aspects of their performance and then repeats the activity with desired changes. The person then reviews the newly recorded performance to verify that the desired change has been made. Performances captured via a video camera allow the person engaged in a sporting activity to perform the activity without the need to change the orientation of all or part of their body which can affect or impair the ability to perform the activity or movement. Video capture also allows viewing of the activity from various orientations. The drawback with this methodology is that the person engaged in the sporting activity can not observe themselves in real time. They must record a performance, review it, make adjustments mentally, then attempt to perform the activity with desired changes, and then repeat the cycle of performing/recording, reviewing, analyzing, repeating.

### SUMMARY OF THE INVENTION

U.S. Pat. No. 6,881,067 B2, Tarry, describes a “Video Instructional System and Method For Teaching Motor Skills” using a video camera and a head mounted display which allows the person performing the physical activity to observe themselves performing the activity in real time without the need to change the position or orientation of their head or eyes.

The device described herein improves on the device described by U.S. Pat. No. 6,881,067 B2 for some situations by linking the video camera to the head mounted display with a wireless transmitter and receiver. This modification allows the device to be used in virtually any environment (e.g., on a golf course or a fishing pond) where electrical power may not be readily available and time to set up and tear down the equipment set up may be limited. In addition the person performing the physical activity is freed from encumbrances imposed by cabling required for audio or video transmission, electrical power or data communications. A further advantage of using wireless connectivity is that the person performing the physical activity can utilize remote control type devices to switch between multiple individual views of their performance.

Wireless connectivity also removes any restrictions on distance from the camera equipment. For example, sprinters, marathoners, or other runners can examine their stride while running either by a fixed camera or from cameras on moving platforms. Natural extension would enable the participants to view real-time feeds from alternative sources such as broadcast network television cameras during competitions.

### BRIEF DESCRIPTION OF THE DRAWINGS

The description herein makes reference to the accompanying drawings wherein like reference numerals refer to like parts throughout the several views, and wherein:

FIG. 1 is a typical application for the device in which the person is learning fly casting; and

FIG. 1a is a representation of the view that the person learning the activity in FIG. 1 (in this example fly casting) sees in the head mounted display; and

FIG. 2 is a preferred embodiment of the device; and

FIG. 3 depicts optional elements of the preferred embodiment displayed in FIG. 2.

### DETAILED DESCRIPTION

Reference will now be made in detail to embodiments of the invention, examples of which are illustrated in the accompanying drawings.

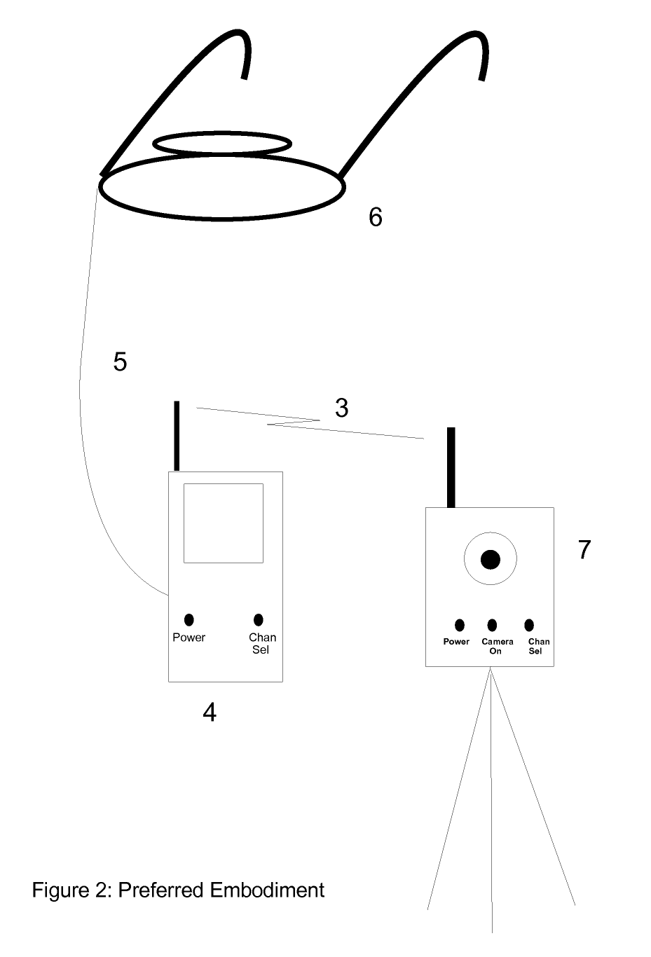

FIG. 2 is a preferred embodiment of the device in which a wireless, battery powered, video monitor, such as currently available for monitoring babies, provides the basic video system comprising the remote video camera and transmitter 7 is mounted on a tripod to provide the video signal. The camera/transmitter transmits the video imagery and associated audio signaling via radio signals 3 to the video receiver 4. The received audio signaling and video imagery is transmitted to the head mounted display 6 using an audio/video connector 5. The audio video connector may also be replaced with a wireless connection. A number of video camera/transmitter and video receiver devices are commercially available for such applications as baby monitoring. One such device is the Wireless Baby Camera with Receiver, model 78601, available from the Smarthome Company of Irvine, Calif. A number of head mounted displays are also commercially available. One such device is the Innovatek V-490 i Glasses Virtual Video HMD Monitor available from the MP3Player Store of Montreal, Quebec, Canada.

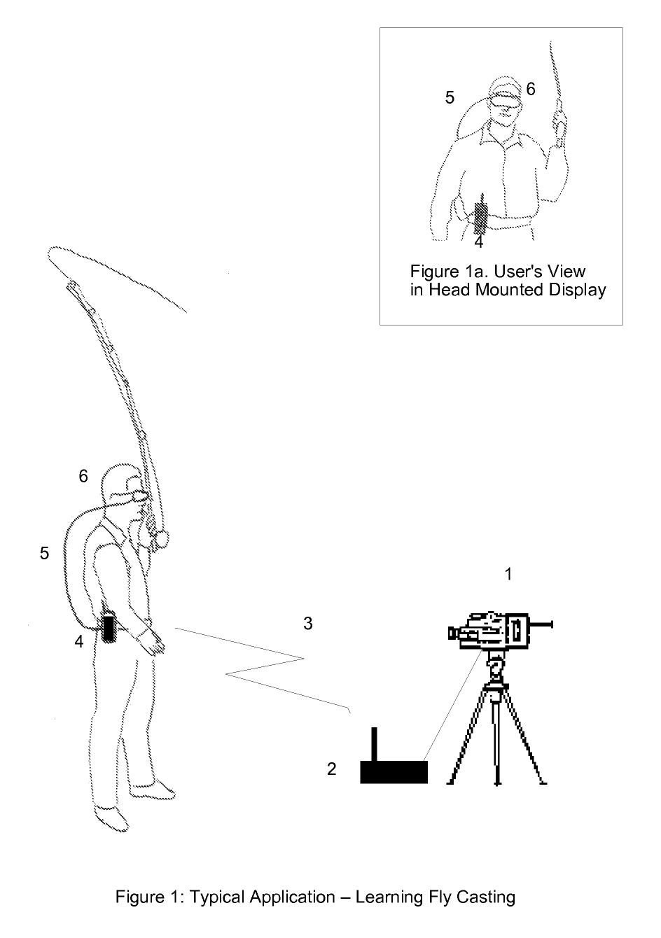

FIG. 1 depicts a typical application in which the camera 1 and video transmitter 2 are separate devices. This embodiment allows higher quality video devices to be used or cameras capable of simultaneously recording the practice session while providing real time imagery to the person performing the physical activity. In this drawing the person is engaged in learning fly casting. FIG. 1a provides a representative view of what the person performing the physical activity sees in their head mounted display.

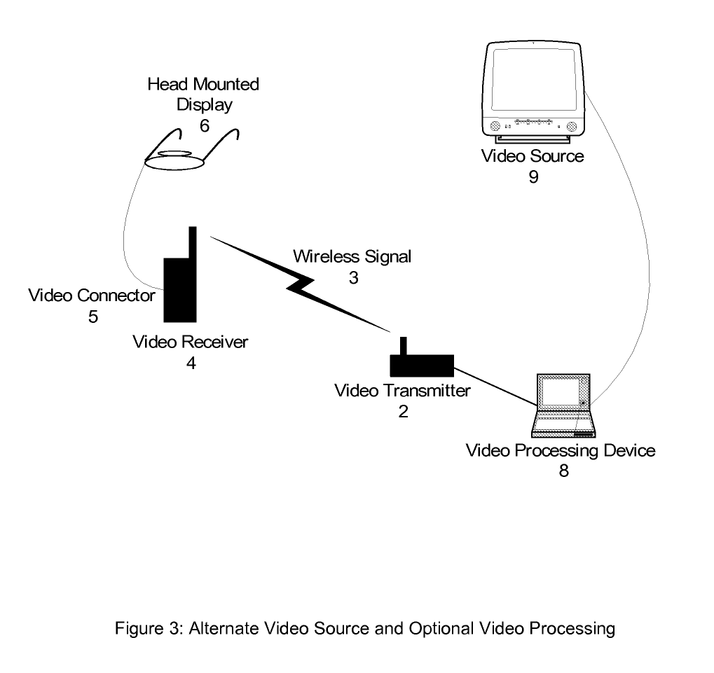

FIG. 3 depicts the optional elements of using an alternative video source 9 such as a real time broadcast viewed on a television. In this case the audio and video output connections of the television could be used to provide the audio and video signal to be presented to the person performing the physical activity. Also in FIG. 3 the audio and video signal passes through a video processing device 8 such as a laptop computer which allows the imagery to be enhanced or augmented with additional information prior to presentation to the user. Such additional information could include an overlay of an expert performing the physical activity or indications of speed or acceleration.

1. A sports training device to deliver real time video imagery of a person engaged in a sporting activity to the person engaged in the sporting activity. The device allows the person engaged in the sporting activity to observe position and movement that would not normally be visible to the person engaged in the sporting activity. By incorporating a head mounted display the sports person can directly observe their physical motion and placement without modifying body orientation or position normally associated with the activity. The head mounted display is binocular in nature and includes eye cups so that the activity can be performed in bright light conditions without compromising the ability to view the display. A wireless connection between the camera and a receiver carried on the person performing the physical activity permits full freedom of movement for the person performing the activity.

2. A device as claimed in claim 1, in which an alternative video source such as a television broadcast provides the imagery presented to the person engaged in the physical activity.

3. A device as claimed in claim 1, wherein a plurality of video sources are provided for video feedback from multiple viewpoints and imagery from a desired plurality of the sources can be selected for viewing by the person engaged in the sporting activity.

4. A device as claimed in claim 1, in which a video processing device provides the ability to modify the video imagery in real time or to record the imagery.

5. A device as claimed in claim 1, wherein the head mounted display is a monocular display allowing the person engaged in the sporting activity to observe themselves performing the activity while simultaneously engaging in the activity.

6. A device as claimed in claim 1, wherein the head mounted display provides a floating display allowing the person engaged in the sporting activity to observe themselves performing the activity while simultaneously engaging in the activity.

7. A device as claimed in claim 1, wherein video imagery from a plurality of video sources can be summed together providing comparative analysis of movement and position.

8. A device as claimed in claim 1, wherein video imagery from a plurality of video sources can be summed together providing analytic feedback of movement and position.

9. A device as claimed in claim 1, wherein means are provided for storage of audio and video imagery for later analysis.

10. A device as claimed in claim 1, means are provided for storage of audio and video imagery for later playback.

11. A device as claimed in claim 1, wherein the connection between any two or more components is wireless.

12. A device as claimed in claim 1, wherein some or all of the components are battery or self powered allowing for operation without impeding the person engaging in the sporting activity.

13. A device as claimed in claim 1, wherein the head mounted display provides a single image to both eyes, split screen image to both eyes, or separate images to each eye.

14. A device as claimed in claim 9, wherein two or more video signals could provide binocular (3D) imagery to the user.

15. A device as claimed in claim 1, wherein a third party analysis system could accept video from either the camera(s) or the processed video output for post processed or real-time feedback via the external video sources to the user.

16. A device as claimed in claim 1, wherein a plurality of additional audio/video receivers and display devices provide the ability for a person or persons acting in a coaching capacity to observe the imagery that is being viewed by the person engaged in the sporting activity.

17. A device as claimed in claim 1, wherein means are provided for a person or persons acting in a coaching capacity to select imagery from multiple sources for viewing by the person engaged in the sporting activity.
